(19) United States
(12) Patent Application Publication
(10) Pub. No.: US 2006/0054201 A1
(43) Pub. Date: Mar. 16, 2006

(54) Sump assembly of dishwasher

(75) Inventors: Sang Heon Yoon, Seoul (KR); Nung Seo Park, Bupyeong-gu (KR); Byung Hwan Ahn, Changwon-si (KR); Dae Yeong Han, Seoul (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/102,880

(22) Filed: Apr. 11, 2005

(30) Foreign Application Priority Data
Sep. 14, 2004 (KR) P2004-73396

(51) Int. Cl. B08B 3/00

(52) U.S. Cl. 134/56 D; 134/58 D

(57) ABSTRACT

A sump assembly of a dishwasher stores water to be supplied to spray nozzles. The sump assembly includes a sump housing for storing water; a heater assembly for heating the stored water; and a water supply pump for pumping the heated water from inside the sump housing above the heater assembly. The water supply pump has an impeller, provided inside the sump housing and disposed above the heater assembly, for forcing the heated water out of the sump housing. The sump housing of the sump assembly is provided with a heater port, which is an opening formed in a lateral side one of the sump housing for receiving the heater assembly, so that a manual operator can unload the heater assembly from and load the heater assembly into the sump housing, while acting externally with respect to the sump assembly. The heating assembly includes a heating unit, installed in the heater port, for generating heat energy; and a packing plug, fitted to the opening of the heater port, for receiving the heating unit; and a pressurizing mechanism, configured to compress the packing plug, for sealing the opening of the heater port.

### CROSS-REFERENCE TO RELATED APPLICATIONS

This application claims the benefit of Korean Application No. 10-2004-0073396 filed on Sep. 14, 2004, which is hereby incorporated by reference.

### BACKGROUND OF THE INVENTION

1. Field of the Invention

The present invention relates to a dishwasher, and more particularly, to a sump assembly of a dishwasher, in which water is stored to be supplied to spray nozzles.

2. Discussion of the Related Art

A dishwasher is a home appliance for washing tableware and other articles to be washed by the articles with water under pressure using a set of spray nozzles. A general dishwasher consists of a tub having a washing chamber inside, a plurality of racks provided within the tub for accommodating the articles to be washed, a plurality of spray nozzles for spraying water toward the racks, and a sump assembly for storing water and supplying the water to the spray nozzles. In the operation of such a dishwasher, clean water supplied from an external source is stored in the sump assembly, and the sump assembly supplies the stored water to the spray nozzles under pressure. The spray nozzles spray water toward articles placed in the racks within the tub. Since high-pressure alone is generally insufficient to effect a thorough cleaning of most articles being washed, a heating element is typically provided to heat the water before spraying, in effort to remove food particles and other remnants from all surfaces of the articles being washed.

In a contemporary dishwasher, however, the application of a heating element as described above presents difficulties, for example, in the integration of a heating element with the sump assembly while maintaining good heating efficiency. Additional problems include an increase in the manipulation of dishwasher components, including parts of the sump assembly and the sump assembly itself, that may be required when servicing or replacing the heating element or related assembly components.

### SUMMARY OF THE INVENTION

Accordingly, the present invention is directed to a sump assembly of a dishwasher that substantially obviates one or more problems due to limitations and disadvantages of the related art.

An object of the present invention is to provide a sump assembly of a dishwasher, which enhances dishwasher performance so that food particles and other remnants adhering to surfaces of the articles being washed can be completely removed.

Another object of the present invention is to provide a sump assembly of a dishwasher, by which high heating efficiency is maintained in the system so that heated water can be supplied to a spray arm without the heated water experiencing excessive heat loss.

Another object of the present invention is to provide a sump assembly of a dishwasher, which facilitates installation, removal, and servicing of a heater assembly by enabling its detachment and reattachment from outside a sump housing that is fully assemble into a sump assembly.

A further object of the present invention is to provide a sump assembly of a dishwasher, which effectively prevents water leakage while integrating a heater and a sump housing.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages in accordance with the purpose of the invention, as embodied and broadly described herein, there is provided a sump assembly of a dishwasher, comprising a sump housing for storing water; a heater assembly for heating the stored water; and a water supply pump for pumping the heated water from inside the sump housing above the heater assembly. The water supply pump has an impeller, provided inside the sump housing and disposed above the heater assembly, for forcing the heated water out of the sump housing.

In another aspect of the present invention, there is provided a dishwasher, comprising a washing chamber for accommodating articles to be washed; a sump housing, disposed under the washing chamber, for collecting and storing water; a heater assembly for heating the stored water; a water supply pump, coupled to the sump housing, for pumping the heated water from inside the sump housing above the heater assembly; and at least one spray nozzle, communicating with the sump housing, for spraying the pumped water into the washing chamber.

The sump housing of the sump assembly according to the present is provided with a heater port, which is an opening formed in a lateral side one of the sump housing for receiving the heater assembly, so that a manual operator can detach (unload) the heater assembly from and reattached (load) the heater assembly to the sump housing, while acting externally with respect to (outside of) the sump assembly.

Preferably, the heating assembly comprises a heating unit, installed in the heater port, for generating heat energy; and a packing plug, fitted to the opening of the heater port, for receiving the heating unit; and a pressurizing mechanism, configured to compress the packing plug, for sealing the opening of the heater port.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a dishwasher according to the present invention;

FIG. 2 is an exploded view of a sump assembly according to the present invention;

FIG. 3 is an exploded view of the heater assembly and the sump housing shown in FIG. 2;

FIGS. 4A and 4B are cross-sectional views of a fixing mechanism of the heater assembly and the sump housing shown in FIG. 2, illustrating before and after states of a pressurization of the fixing mechanism, respectively; and

FIG. 5 is a cross-sectional view of one end of the heater element, clamp, and sump housing shown in FIG. 2.

### DETAILED DESCRIPTION OF THE INVENTION

Reference will now be made in detail to the preferred embodiments of the present invention, examples of which are illustrated in the accompanying drawings. Wherever possible, like reference numbers will be used throughout the drawings to refer to the same or similar parts.

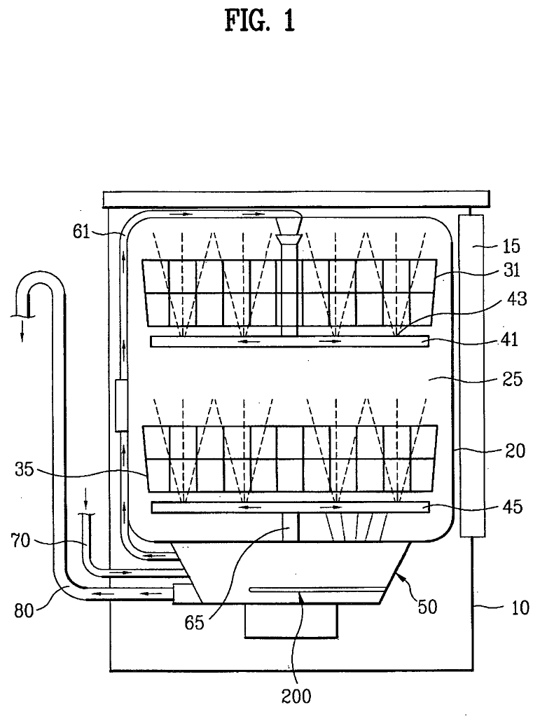

Referring to FIG. 1, illustrating a dishwasher according to the present invention, a tub 20 is provided within a case 10 forming an exterior of a dishwasher, and a door 15 for opening/closing the tub 20 is provided to one side of the case 10. A washing chamber 25 for accommodating tableware and other articles to be washed is provided within the tub 20. At least one rack for loading the articles to be washed is provided to the washing chamber 25, and as shown in FIG. 1, an upper rack 31 is provided to an upper part of the washing chamber 25 and a lower rack 35 is provided to a lower part of the washing chamber 25. At least one spray arm is provided within the washing chamber 25 adjacent each rack, and as shown in FIG. 1, an upper arm 41 is arranged under the upper rack 31 and a lower arm 45 is arranged under the lower rack 35. The upper and lower arms 41 and 45 are each rotatable, and each of the upper and lower arms 41 and 45 includes at least one spray nozzle 43 for spraying water toward articles placed on the racks.

A sump assembly 50 for supplying water to the upper and lower arms 41 and 45 is provided within the case 10, e.g., under the tub 20. The sump assembly 50 is connected to the upper arm 41 via a first connecting pipe 61 and is connected to the lower arm 45 via a second connecting pipe 65. The sump assembly 50 is supplied with water from an external source (not shown) via a water supply pipe 70, stores the thus supplied water, and selectively or simultaneously supplies the stored water to the upper and lower arms 41 and 45 via the first and second connecting pipes 61 and 65, respectively.

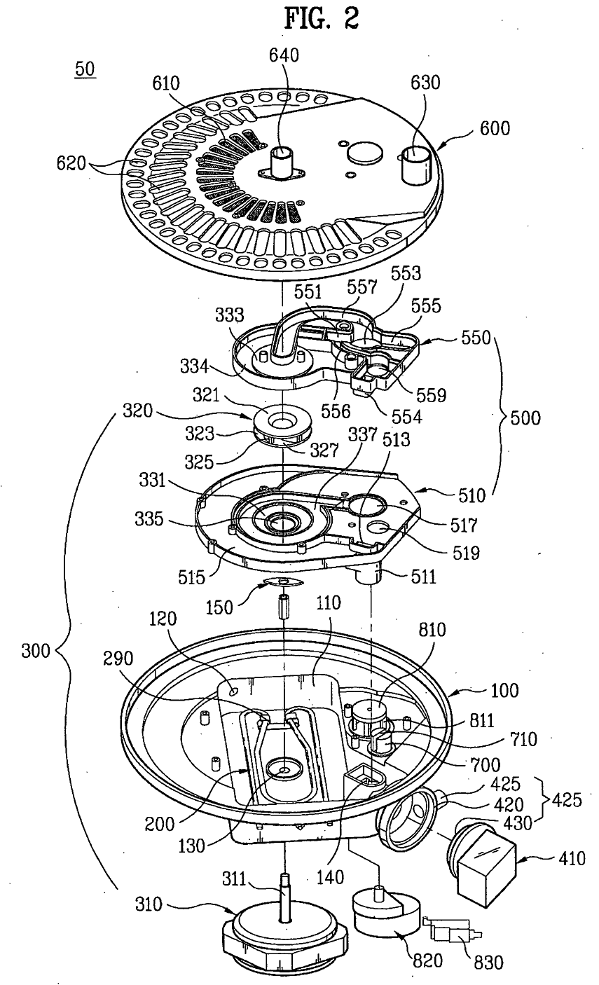

Referring to FIG. 2, the sump assembly 50 according to the present invention includes a sump housing 100 for storing water, a heater assembly 200 for heating the stored water, a drain pump 400 for draining the water from the sump assembly to be expelled from the dishwasher, a water supply pump 300 for pumping the water stored in the sump housing 100, a water guide assembly 500 for supplying the pumped water to the upper and lower arms 41 and 45, and a cover 600 for covering the sump housing 100 and for filtering water.

A recess 110 is centrally provided to a bottom of the sump housing 100 to store the water, and a water supply hole 120 is provided in one side of the recess 100 to be connected to the water supply pipe 70. A drain chamber 140 is provided to the sump housing 100 near the recess 110, and a hole (not shown) communicating with the recess is formed in one side of the drain chamber, which has an open top communicating with a soil chamber 515 provided to the water guide assembly 500.

The drain pump 400 is loaded in a lateral side of the sump housing 100. The drain pump 400 communicates with the drain chamber 140 and thus expels (drains) water from the recess 110, the drain chamber 140, and the soil chamber 515. The drain pump 400 includes an impeller housing 420, a motor 410, and an impeller 430. The impeller housing 420 is coupled to a lateral side of the sump housing 100 and communicates with the drain chamber 140. The impeller housing 420 may be formed integrally with the body of the sump housing 100. A nipple 425 is projected from a lateral side of the impeller housing 420 to be connected to a drain hose 80. The motor 410, having a shaft (not shown) with which the impeller 430 is coupled, is assembled to the impeller housing 420 so that the impeller 430 can be inserted in the impeller housing 420. Hence, once the drain pump 400 is actuated, water contained in the recess 110, the drain chamber 140, and the soil chamber 515 is drained and discharged to the exterior the dishwasher via the drain chamber 140, the drain pump 400, and the drain hose 80.

The water supply pump 300 pumps the water above the heater assembly 200 to supply the water heated by the heater assembly 200 to the spray arms without minimum heat loss. The water supply pump 300 includes a motor 310 having a shaft 311, an impeller 320 connected to the shaft, and an impeller housing and is described with reference to FIG. 2 as follows.

The motor 310 is installed at a bottom of the sump housing 100. The shaft 311, which is connected to the motor 310 at one end and to the impeller 320 at the other end, is installed to penetrate a hole 130 provided to a bottom of the recess 110. A set of disposal blades 150 is assembled to the shaft 311 penetrating the bottom of the sump housing 100. If the motor 310 is actuated, the disposer blades 150 are rotated at high speed to rid the water stored in the recess 110 of large food particles and the like by grinding the particles into finer particles. The impeller 320 is assembled to the shaft 311 as well, to be driven in common with the disposal blades 150. The impeller 320 is situated over the heater assembly 200 and is rotated to force the water, which has been heated by the heater assembly directly below, up from the recess 110 and out of the sump housing 100. The impeller 320 sucks the water in an axial direction and discharges the water in a radial direction. For this, the impeller 320 includes an upper plate 321, a lower plate separated from the upper plate 323 to leave a predetermined gap from each other, and a plurality of blades 325 provided between the upper and lower plates 321 and 323. The upper plate 321 is blocked and an inlet (not shown) is provided to a center of the lower plate 323 to allow water to flow in and thus enter the impeller 320. A hub (not shown) is provided to a center of the upper plate 321 and the shaft 311 is fitted in a lower end of the tub. A plurality of curved blades 325 are provided between the upper and lower plates 321 and 323, and an outlet 327 is provided between the blades 325 to discharge the water having flown in the impeller 320 via the inlet.

Meanwhile, the impeller housing of the water supply pump 300 encloses the impeller 320 to guide the water moved by the impeller 320. The impeller housing is preferably built in one body of the water guide assembly 500 instead of being formed of an independent body. In this case, the water guide assembly 500 includes a lower housing 510 and an upper housing 550, and the impeller housing of the water supply pump 300 is configured by assembling the upper and lower housings 550, whereby portions of the assembly form the impeller housing, which will be explained in detail as follows.

Provided to a top surface of the lower housing 510 of the water guide assembly 500 are an inlet 335 via which the water stored in the recess 110 of the sump housing 100 flows, a lower recessed seat 331 for accommodating a lower part of the impeller 320, and a lower water passage 337 for guiding the water pumped by the impeller 337. The lower recessed seat 331 is provided to enclose the inlet 335, and the inlet 335 communicates with the inlet (not shown) of the impeller 320 situated on the lower recessed seat 331. The lower water passage 337 is provided to enclose the lower recessed seat 331. Meanwhile, provided to a bottom surface of the upper housing 50 of the water guide assembly 500 are an upper recessed seat 333 for accommodating an upper part of the impeller 320 to oppose the lower recessed seat 331, an upper water passage 334 for guiding the water pumped by the impeller 320 to oppose the lower water passage 337, and an outlet 551 for guiding the water pumped from the upper water passage 334 to an upper surface of the upper housing 550. The upper water passage 334 is provided to enclose the upper recessed seat 333, and the output 551 is formed at an end of the upper water passage 334.

Once the motor 310 is actuated, the impeller 320 is rotated in a space defined by the lower and upper recessed seats 331 and 333. The water stored in the recess 110 of the sump housing 100 flows into the impeller 320 via the inlet 335 and the impeller 320 discharges the water in a radial direction. The water discharged from the impeller 320 moves along the water passage defined by the lower and upper water passages 337 and 334 and is finally led to the top surface of the upper housing 550 of the water guide assembly 500 via the outlet 551. A portion of the water thus guided to the top surface of the upper housing 550 is selectively guided to the upper or lower arm 41 or 45 or is simultaneously guided to the upper and lower arms 41 and 45.

The water guide assembly 500 water guide assembly 500 includes the upper and lower housings 550 and 510. The upper housing 550 is provided with a valve receptacle 553 communicating with the outlet 551. First and second guide passages 555 and 557 for supplying the water to the upper and lower arms 45 and 41 are each connected to the valve receptacle 553. In this case, the first guide passage 555 is provided to the top surface of the upper housing 550 from the valve receptacle 553 to a perimeter point of the upper housing 550, while the second guide passage 557 is provided to the top surface of the upper housing 550 from the valve receptacle 553 to a central point of the upper housing 550. A diverting valve 810 is situated at the valve receptacle 553 to guide a portion of the water flowing from the outlet 551 to the first or second guide passages 555 or 557 selectively or to the first and second guide passages 555 and 557 simultaneously. Provided to a lateral side of the diverting valve 810 are a plurality of passages via which the first and second guide passages 555 and 557 communicate with each other and a rib 811 enabling the first or second guide passage 555 or 557 to be selectively blocked. The diverting valve 810 is loaded in the sump housing 100 and to be situated at the valve receptacle 553 when the water guide assembly 500 is assembled to the sump housing 100. For this, a hole 517 is formed at the lower housing 510 to correspond to the valve receptacle 553 so that the diverting valve 810 can be passed through the hole 517.

A driving mechanism for actuating the diverting valve 810 is provided under the sump housing 100. The driving mechanism includes a crank 820 connected to the diverting valve 810, a linkage 830 connected to the crank 820, and a power source, e.g., a stepper motor (not shown), connected to the linkage 830. The linkage makes a rectilinear reciprocation by the step motor, whereas the crank 820 converts the rectilinear reciprocation to a rotational motion of the diverting valve 810. Hence, when the dishwasher washes or rinses the dishes, the diverting valve 810 is reversibly rotated by the driving mechanism. In doing so, the rib 811 selectively blocks one or both of the first and second guide passages 555 or 557. Thus, the water pumped by the water supply pump 300 is supplied to the first or second guide passage 555 or 557 selectively or to the first and second guide passages 555 and 557 simultaneously. The water led to the first and second guide passages 555 and 557 is supplied to the upper and lower arms 45 and 45, respectively.

Meanwhile, after having been pumped by the water supply pump 300, the rest of the water guided to the top surface of the upper housing 550 of the water guide assembly is used in measuring water contamination levels, is filtered, and is then returned to the sump housing 100 to be stored in the recess 110. This process will now be explained in detail as follows.

A bypass 556 communicating with the outlet 551 is provided to the top surface of the upper housing 550. A sensor receiving portion 559 is provided in the middle of the bypass 556. A sensor assembly 700 is situated in the sensor receiving portion 559 to measure water contamination levels present in the water that flows in the bypass 556 by being pumped by the water supply pump 300. The sensor assembly 700 is loaded in the sump housing 100 to be located at the sensor receiving portion 559 when the water guide assembly 500 is loaded on the sump housing 100. For this, a hole 519 is provided to the lower housing 510 to correspond to the sensor receiving portion 559 and to be penetrated by the sensor assembly 700. A channel 710 communicating with the bypass 556, as shown in FIG. 2, is provided to traverse a center of the sensor assembly 700. Hence, the water flowing in the bypass 556 passes through the channel 710. A light emitting unit (not shown) and a light receiving unit (not shown) are provided within the sensor assembly 700 to oppose each other while interposing the channel 710. A light signal emitted from the light emitting unit is passed through the water flowing in the channel 710 to arrive at the light receiving unit. The sensor assembly 700 measures water contamination levels based on the intensity of the light signal received by the light receiving unit, and the resulting measurements are used as a basis for determining a washing time, a washing number, a rinsing time, a rinsing number, and the like. For instance, a weak light signal arriving at the light receiving unit indicates the presence of highly contaminated water, whereby the dishwasher exchanges the water or performs another washing or rinsing.

Water having passed through the sensor assembly 700 reaches a first drain 554 provided to an end of the bypass 556. The first drain 554 is connected to a second drain 513 provided to the lower housing 510 and extends to the drain chamber 140 of the sump housing 100 from the lower housing 510. Hence, the rest of the water, which is introduced into the top surface of the upper housing 550 after having been pumped by the water supply pump 300, is passed through the bypass 556, the sensor assembly 700, and the first and second drains 554 and 513 to flow into the drain chamber 140. The water in the drain chamber 140 is not discharged outside via the drain hose 80 unless the drain pump is actuated 400. Since a check valve (not shown), for opening/closing the unseen hole via which the drain chamber 140 and the recess 110 communicate with each other, is provided to the drain chamber 140, the water in the drain chamber 140 is not introduced into the recess 110 as well. Hence, the water introduced into the drain chamber 140 ascends along a third drain 511 to enter the soil chamber 515 of the lower housing 510 and flow in the soil chamber 515. In doing so, contaminants in the water are precipitated, whereby the heavier contaminants settle into the drain chamber 140 while lighter contaminants settle in the soil chamber 515. Filtering occurs as the water in the soil chamber 515 overflows (exits) through the cover 600.

The soil chamber 515 is provided to the lower housing 510, enclosing the impeller housing of the water supply pump 300, and receives and stores the water passed through the bypass 556 and the drain chamber 140 after the water has pumped by the water supply pump 300. If the water keeps flowing into the soil chamber 515, a water level of the soil chamber 515 rises to a level where the water finally floods out of the soil chamber 515.

Meanwhile, the cover 600, having a generally disc-like shape, covers the water guide assembly 500 and the sump housing 100 and has a multitude of overflow vents centrally arranged and disposed over the soil chamber 515. The overflow vents are covered by a mesh 610 for filtering water exiting the sump housing 100, and more specifically, the soil chamber 515, via the cover. Hence, water flooding from the soil chamber 515 passes through the mesh 610 to be filtered, leaving the filtered-out particles in the soil chamber. A multitude of drain apertures 620, provided to a perimeter area of the cover 600, allow contaminated water draining inside the washing chamber 25 to enter to the sump housing 100 along with the filtered water flooding from the soil chamber 515 and passed through the filter 610. All the water thus entering the sump housing 100 is stored in the recess 110 at the center of the sump housing 100. A top surface of the cover 600 has a first nipple 630 communicating with the first guide passage 555 of the water guide assembly 500 provided near its edge and has a second nipple 640 communicating with the second guide passage 557 of the water guide assembly 500 provided at its center. The first connecting pipe 61 connected to the upper arm 41 is connected to the first nipple 630, and the second connecting pipe 65 connected to the lower arm 45 is connected to the second nipple 640. Hence, water introduced into the first guide passage 555 is supplied to the upper arm 41 via the first nipple 630 and the first connecting pipe 61, while water introduced into the second guide passage 557 is supplied to the lower arm 45 via the second nipple 640 and the second connecting pipe 65.

A dishwasher adopting a sump assembly according to the present invention enables high water-heating efficiency so that the water applied to articles being washed retains its intended high temperature for good washing efficiency using water heated in the recess 110 of the sump housing 100. For this, the heater assembly 200 is provided within the sump housing 100 to heat water stored in the recess 110. Meanwhile, the heater assembly 200 is detachably provided to the sump assembly 50, and specifically within the sump housing 100, so as to enable both detachment and reattachment operations to be performed externally with respect to the sump housing 100 while the sump assembly remains fully assembled. That is, with the sump assembly 50 remaining in a fully assembled state with respect other dishwasher components, including the sump housing 100, the water supply pump 300, the drain pump 400, and even the tub 20 if necessary, a user is provided unimpeded access to perform servicing on the heater assembly 200.

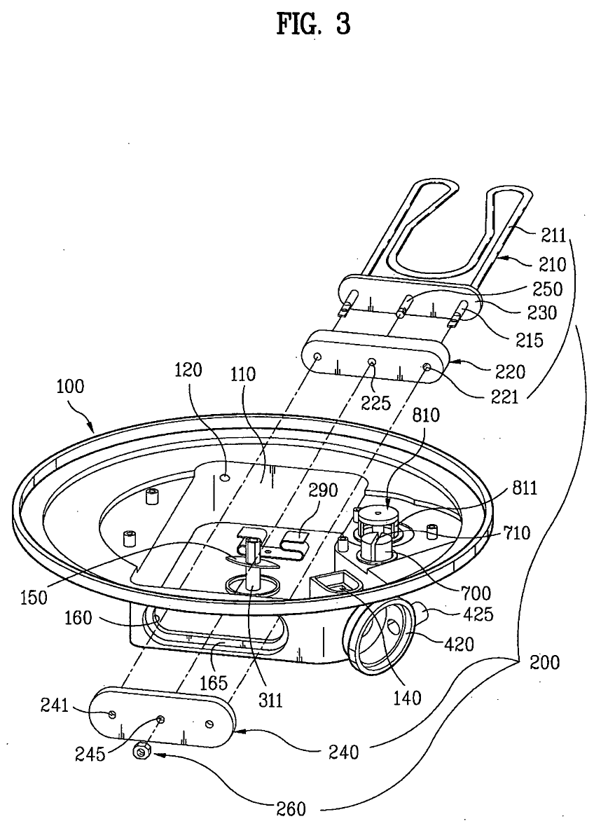

As shown in FIG. 3, the heater assembly 200 is situated at a bottom of the sump housing 100, e.g., a bottom of the recess 110, to correspond with a heater port 160 provided to a lateral side of the sump housing 100. The heater assembly 200, which is loaded into the sump housing 100 via the heater port 160, includes a heating unit 210 for generating heat energy to heat water and a fixing mechanism for fixing the heating unit 210 to the sump housing 100 while enabling its detachment and reattachment with respect to the sump housing 100, from the exterior of the sump housing 100, without disassembly of the sump assembly 50.

The heating unit 210 includes a heating element 211 to be arranged within the sump housing 100 of the sump assembly 50, and more particularly, within the recess 110, to heat water contained in the recess, and a pair of terminals 215 respectively connected at the termini of the heating element 211 so as to project, via the heater port 160, from the lateral side of the sump housing and thus to provide accessibility from the outside of the sump housing. The heating element 211 is essentially an electrical conductor that is bent into a predetermined formation, including several bends covering a wide are, so that heat transfer can occur evenly throughout the recess 110 while avoiding interference with other internal components or external (e.g., the drain pump 400) components of the sump housing 100, and particularly the working components of the water supply pump 300, whenever the heater assembly 200 is inserted or extracted via the heater port 160. For example, the predetermined formation of the heating element 211 has a generally U-shaped configuration substantially encompassing the shaft 311 of the water supply pump 300, so that insertion and extraction can be performed while the shaft 311 and the disposal blades 150 remain installed, i.e., an assembled state whereby the shaft fully passes through the sump housing 100 and connects with the impeller 320.

When inserted through the heater port 160 to be placed in an installed (assembled) state, one end of the heating unit 210 is fixed to the sump housing 100 by the fixing mechanism of the heater assembly 200. The fixing mechanism of the present invention is realized by a packing plug 220 fitted to the heater port 160 such that the terminals 215 of the heating unit 210 extend through the packing plug to the exterior of the sump housing 100. Preferably, the packing plug 220 is formed of a pliable material and is provided with a pair of preformed holes 221 for respectively receiving the pair of terminals 215. The heating unit 210 is stably fixed to the sump housing 100 by forming the packing plug 220 to establish a very tight fit within the heater port 160, as well as with respect to the heating unit 210 and the terminals 215, which also seals the heater port to prevent leakage from the sump housing. The formation of the packing plug 220 allows the heater assembly 200 to be separated from the sump assembly 50 by simply pulling the heater assembly from outside of the sump housing 100.

While the heating unit 210 can be stably loaded into and easily unloaded from the sump housing 100 using only the above basic structure, the sealing and fixing properties of the fixing mechanism can be further facilitated by providing a pressurizing mechanism operating in conjunction with the fixing mechanism. The pressurizing mechanism compresses the material of the packing plug 220 while placed in the heater port 160, thereby partially deforming the packing plug, which expands peripherally with the heater port to increase the sealing power of the packing plug. With the sealing power thus increased so that the packing plug 220 is more tightly fitted inside the heater port 160, the packing plug is less likely to escape the heater port when the heater assembly 200 is coupled to the sump housing 100, which also enhances the stability of the heating unit 210 inside the sump housing as well as the stability of the heater assembly's overall coupling to the sump assembly 50.

The pressurizing mechanism of the present invention includes inner and outer plates 230 and 240, opposing each other and interposing the packing plug 220; and a compression device, coupled to each of the inner and outer members and operably accessible (i.e., tightening and loosening) from outside of the sump housing 100, for controlling the separation between the inner and outer plates and thus pressurizing or depressurizing the packing plug. The inner plate 230 is disposed on the interior side of one wall of the sump housing 100 in correspondence to the heater port 160; the outer plate 240 is correspondingly disposed on the exterior side of the sump housing 100 to cover fully the opening of the heater port 160 and is supported at its perimeter by an outer surface of the sump housing 100. An outer recess 165 may be formed in the outer surface of the sump housing 100 so that, when the outer plate 240 is fitted to the heater port 160, the outer surface of the outer plate is flush with the outer surface of the sump housing. The inner plate 230, which abuts one face of the packing plug 220 and is preferably connected to the heating unit 210, has a size and shape substantively equal to or slightly smaller than that the heater port 160, enabling an insertion of the heating unit and inner plate coupled with the packing plug to dispose the heating unit within the recess 110 of the sump housing 100. Here, the insertion is performed via the heater port 160 and can be performed from outside of the sump housing 100. Meanwhile, the second member 240, which abuts the other face of the packing plug 220, is seated in the outer recess 165, is substantively larger than the heater port 160 and thus cannot pass through the opening of the heater port 160. The second member 240 is provided with a pair of through holes 241 for receiving the terminals 215 of the heating unit 210.

The compression device includes, for example, a bolt 250 extending from the inner plate 230 and having a threaded distal end for receiving a nut 260, which is disposed on the anterior side of the outer plate 240. Thus, the packing plug 220 is provided with a packing through hole 225 centrally disposed to receive the bolt 250, which is passed through the packing plug when the heating unit is first inserted into the heater port 160 together with the packing plug, and the outer plate 240 is provided with a plate through hole 245 correspondingly formed to receive the bolt when the outer plate is seated in the outer recess 165. Accordingly, the bolt 250 extends from the first member 230 to be passed through the packing plug 210 and outer plate 240, via the through holes 225 and 245 of the packing plug and outer plate, respectively, and is then projected from the lateral side of the sump housing 100 and thus to provide accessibility from the outside of the sump housing. That is, the nut 260 is coupled to the bolt 250, from outside of the sump housing 100, and is then tightened to draw the inner plate 230 toward the outer plate 240 to pressurize the packing plug 220. On the other hand, loosening the nut 260 relaxes the compression force exerted on the material of the packing plug 22 and thus increases the separation between the inner and outer plates 230 and 240 to depressurize the packing plug 220.

In assembling the above-configured heater assembly 200, an assembly of the heating unit 210 and the inner plate 230 is preferentially inserted into the sump housing 100 via the opening of the heater port 160, and the packing plug 220 is then fitted to the opening by threading and externally exposing the terminals 215 of the heating unit and the bolt 250 of the compression device through the preformed through holes 221 and the packing through hole 225. Once the packing plug 220 is thus fitted, the outer plate 240 is similarly threaded over the terminals 215 and the bolt 250 to be seated into the outer recess 165. Thereafter, the nut 260 is coupled with the bolt 250 and tightened to perform pressurization.

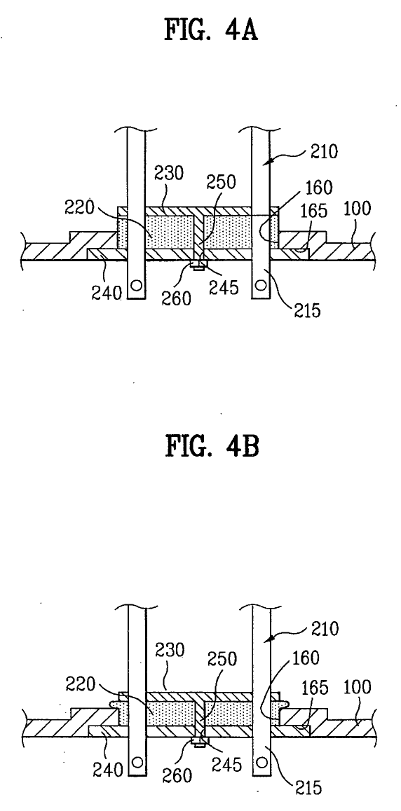

As shown in FIG. 4A, i.e., before a tightening of the nut 260 and before pressurization of the packing plug 220, the heater assembly 200 is incompletely fixed to the sump housing 100, since each of the packing plug 220 and the inner plate 230 have a size enabling passage through the opening of the heater port 160, which allows the heater assembly 200 to be separated from the sump assembly 50 by pulling the heater assembly 200 out of the sump housing 100. Notably, without the tightening of the nut 260 to compress the material of the packing plug 220, the packing plug has a depth (thickness) greater than the depth of the lateral wall of the sump housing 100 forming the opening of the heater port 160, such that a rear portion of the packing plug protrudes into the interior of the sump housing and is unconstrained by the inner walls of the opening of the heater port. On the other hand, as shown in FIG. 4B, i.e., after a tightening of the nut 260 and after pressurization of the packing plug 220, the compression applied to the packing plug by the compression device of the present invention causes the material of the packing plug to expand, particularly laterally. Since the thickness of the packing plug 220 is greater than the depth of the opening of the heater port 160, the rear portion of the packing plug 220 expands beyond the constraints of the heater port, spilling out over the edges of the opening's interior side. This laterally expanding portion of the packing plug 220 pressed by the compression device of the pressurizing mechanism of the present invention is caught inside the sump housing 100, thus capturing the heater assembly 200, which is locked in the heater port 160 to be fixed to the sump housing. Accordingly, by tightening and loosening the compression device, the heater assembly 200 can be stably (when tightened) fixed to the sump housing 100 of the sump assembly 50 and is (when loosened) externally detachable, enabling full access to the heater assembly and its components as desired, for example, when servicing the heater assembly, without any particular disassembly of the sump assembly.

With the heating unit 210 fixed at one (forward) end to the sump housing 100 by the fixing mechanism of the present invention as described above, the other (rearward) end of the heating unit should be positioned and supported within the sump housing. For this, a clamp 290 is fixed near the distal end of the heating element 211, preferably inside the sump housing 100 to an inner bottom surface of the recess 110 near the distal end, to hold in place and steady the position of the heating element 211 of the heating unit 210, which is subject to the forces of flowing water, particularly during a draining operation performed by the drain pump 400.

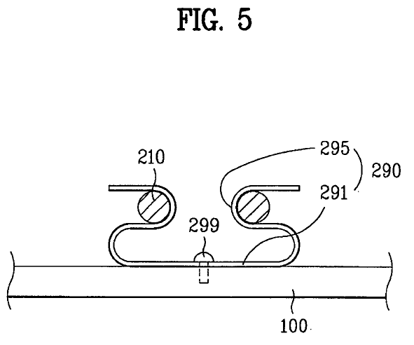

Referring to FIGS. 3 and 5, the clamp 290 has at least one cup 295 having an inner radius for receiving the heating element 211, which is inserted into the cup 295 to be tightly held in place and thus supported. Preferably, an opposing pair of the cups 295 are provided to hold and support the heating element 211 at different points and are connected to each other by a connecting portion 291, which is fixed to the recess 110 by a locking member such as a screw 299 or the like. Accordingly, the clamp 290 slidingly receives and releases the heating element 211 of the heating unit 210 while the heater assembly 200 is being coupled to the sump housing 100 via the heater port 160 and while the heater assembly is being uncoupled from the sump housing via the heater port. That is, when the heater assembly 200 is inserted into the sump housing 100 via the heater port 160, the heating element 211 slides, laterally and lengthwise, to be tightly fitted into the cups 295 and thus fixed to the clamp 290, which is in turn fixed to the bottom of the sump housing 100. Conversely, when the heater assembly 200 is withdrawn from the sump housing 100 via the heater port 160, the heating element slides reversely, to be released from the cups 295. Thus, despite support of a rearward end of the heating unit 210 inside the sump housing 100, there is no interference of movement, i.e., the insertion and extraction of the heating unit 210 or the detachment and reattachment of the heater assembly 200, when externally loading and unloading the heater assembly with respect to the sump assembly 50.

In the operation of the above-configured sump assembly according to the present invention, if the dishwasher initiates a washing or rinsing process, clean water is introduced into the recess 110 of the sump housing 100 via the water supply hole 120 connected to the water supply pipe 70. The water introduced into the recess 110 is then heated by the heater 210. If a corresponding water supply is completed, the motor 310 of the water supply pump 300 is driven so that the impeller 320 pumps the water stored in the recess 110. One portion of the pumped water flows in the valve receptacle 553 via the outlet 551 and is then output (guided) to one or both of the first and second guide passages 555 and 557 according to an operation of the diverting valve 810 and thus sprayed into the tub 20 from one or both spray arms. That is, water output to the first guide passage 555 is supplied to the upper arm 41 to be sprayed onto articles placed on the upper rack 31, while water output to the second guide passage 557 is supplied to the lower arm 45 to be sprayed onto articles placed on the lower rack 35. After washing, the used (contaminated) water drains to the bottom of the tub 20 and enters the sump assembly 50, to be reintroduced into the sump housing 100 via the drain apertures 620 provided in the cover 600 and again be stored in the recess 110. Large particles of the contaminants returned to the recess 110 of the sump housing 100 together with the draining water are ground by the disposal blades 150, disposed between the bottom of the recess and the impeller 320, while smaller particles are pumped along with the water.

Meanwhile, another portion of the water pumped by the impeller 320 is for immediate recirculation and is introduced into the bypass 556 and passes through the channel 710 of the sensor assembly 700 for water contaminant level determination. According to the determined water contaminant level, the dishwasher may adjust automatically various dishwashing parameters, including a washing or rinsing duration or a number of wash/rinse repetitions.

The water having passed through the channel 710 of the sensor assembly 700 is introduced into the drain chamber 140 via the first and second drains 554 and 513. In doing so, with the drain pump 400 is inactive, the water is retained in the drain chamber 140 and enters (flows in) the soil chamber 515 via the third drain 511, whereby contaminants in the water are precipitated and filtering occurs as the water in the soil chamber 515 rises and overflows through the cover 600 and is forced out the overflow vents 615, through the mesh 610, and back into the drain apertures 620 to be re-introduced into the sump housing 100. Any contaminant particles that are introduced into the soil chamber 515 but are too large to pass through the mesh 610 simply accumulate in the soil chamber until a drain operation is performed by the drain pump 400 upon completion of a washing or rinsing cycle or when excess contaminant levels are determined, whereby the entire contents of the soil chamber 515, the drain chamber 140, and the recess 110 of the sump housing 100 are discharged via the drain hose 80. As described above, a prescribed quantity of the pumped water is passed through the bypass 556 to be purified by the filter 610 and is then re-supplied to the sump housing 100. In doing so, though the soil chamber 515 and the mesh 610 may seem to be filtering only a small quantity or percentage of the water, excellent water-filtering performance is achieved due to their continuous operation throughout any washing or rinsing cycle.

The sump assembly according to the present invention as described above enhances dishwasher performance so that food particles and other remnants adhering to surfaces of the articles being washed can be completely removed, by maintaining high heating efficiency in the system so that heated water can be supplied to a spray arm without the heated water experiencing excessive heat loss. In addition, since the heater assembly is loaded in the sump housing by the fixing and pressurizing mechanisms according to the present invention enable an externally oriented loading and unloading of the heater assembly with respect to the sump assembly, thus facilitating installation, removal, and servicing of a heater assembly by enabling its detachment and reattachment from outside the sump housing, i.e., without disassembly of the sump assembly, while leakage from occurring at connection between the sump housing and the heater assembly.

It will be apparent to those skilled in the art that various modifications and variations can be made in the present invention. Thus, it is intended that the present invention covers such modifications and variations provided they come within the scope of the appended claims and their equivalents.

What is claimed is:

1. A sump assembly of a dishwasher, comprising:
a sump housing for storing water;
a heater assembly for heating the stored water; and
a water supply pump for pumping the heated water from inside said sump housing above said heater assembly.

2. The sump assembly of claim 1, wherein said water supply pump is coupled to said sump housing.

3. The sump assembly of claim 1, wherein said heater assembly is coupled to said sump housing.

4. The sump assembly of claim 3, wherein said heater assembly is configured in said sump housing to enable detachment and reattachment of said heater assembly from outside of said sump housing.

5. The sump assembly of claim 4, wherein the detachment and reattachment is performed externally via an opening formed in a lateral side of said sump housing.

6. The sump assembly of claim 1, wherein said heater assembly is disposed at a bottom of said sump housing.

7. The sump assembly of claim 6, wherein the bottom of said sump housing is recessed.

8. The sump assembly of claim 7, wherein said heater assembly is disposed in the recess formed in said sump housing.

9. The sump assembly of claim 8, wherein said heater assembly is submergible in water contained in the recess.

10. The sump assembly of claim 1, wherein the water stored in said sump assembly is contained in a recess formed in a bottom of said sump assembly.

11. The sump assembly of claim 10, wherein said heater assembly is disposed in the recess.

12. The sump assembly of claim 1, said water supply pump comprising:
an impeller, provided inside said sump housing and disposed above said heater assembly, for forcing the heated water out of said sump housing.

13. The sump assembly of claim 12, said water supply pump further comprising:
a motor, disposed under said sump housing, for driving said impeller via a shaft coupled to said motor and said impeller.

14. The sump assembly of claim 13, wherein the shaft passes through a bottom of said sump housing.

15. The sump assembly of claim 13, wherein said heater assembly has a configuration avoiding interference with the shaft while said heater assembly is coupled to said sump housing and while said heater assembly is uncoupled from said sump housing.

16. The sump assembly of claim 12, said water supply pump further comprising:
at least one disposal blade, rotatably provided within said sump housing to be disposed between said impeller and a bottom of said sump housing, for grinding refuse included in the stored water.

17. The sump assembly of claim 16, wherein said impeller and said at least one disposal blade are commonly driven.

18. The sump assembly of claim 16, wherein the heater assembly is configured to enclose the disposer.

19. The sump assembly of claim 16, wherein said heater assembly has a configuration avoiding interference with said at least one disposal blade while said heater assembly is being coupled to said sump housing and while said heater assembly is being uncoupled from said sump housing.

20. The sump assembly of claim 1, said sump housing comprising:
a heater port having an opening formed in a lateral side one of said sump housing for receiving said heater assembly.

21. The sump assembly of claim 20, wherein said heater assembly is passed through the opening of said heater port to be disposed inside said sump housing.

22. The sump assembly of claim 20, wherein said heater assembly has a configuration avoiding interference with internal components of said sump housing while said heater assembly is being coupled to said sump housing via said heater port and while said heater assembly is being uncoupled from said sump housing via said heater port.

23. The sump assembly of claim 20, wherein said heater assembly has a configuration avoiding interference with external components of said sump housing while said heater assembly is being coupled to said sump housing via said heater port and while said heater assembly is being uncoupled from said sump housing via said heater port.

24. The sump assembly of claim 20, wherein said heater assembly has a configuration avoiding interference with working components of said water supply pump while said heater assembly is being coupled to said sump housing via said heater port and while said heater assembly is being uncoupled from said sump housing via said heater port.

25. The sump assembly of claim 20, said heater assembly comprising:
a heating unit, installed in said heater port, for generating heat energy; and
a packing plug, fitted to the opening of said heater port, for sealing the opening.

26. The sump assembly of claim 25, wherein said heating unit is passed through said packing plug.

27. The sump assembly of claim 26, wherein said packing plug has at least one preformed hole for receiving said heating unit.

28. The sump assembly of claim 25, wherein said heating unit is installed in said heater port by being passed through said packing plug.

29. The sump assembly of claim 25, further comprising:
a clamp, fixed to said sump housing, for positioning and supporting said heating unit.

30. The sump assembly of claim 29, wherein said clamp supports a distal end of said heating unit.

31. The sump assembly of claim 29, wherein said clamp slidingly receives and releases said heating unit while said heater assembly is being coupled to said sump housing via said heater port and while said heater assembly is being uncoupled from said sump housing via said heater port.

32. The sump assembly of claim 29, wherein said clamp includes at least one cup for being fitted with said heating unit.

33. The sump assembly of claim 25, said heater assembly further comprising:
a pressurizing mechanism, configured to compress said packing plug, for increasing a sealing power of said packing plug.

34. The sump assembly of claim 20, said heater assembly comprising:
a heating unit, installed in said heater port, for generating heat energy;
a packing plug, fitted to the opening of said heater port, for receiving said heating unit; and
a pressurizing mechanism, configured to compress said packing plug, for sealing the opening of said heater port.

35. The sump assembly of claim 34, wherein said heater assembly is coupled to said sump housing.

36. The sump assembly of claim 35, wherein said pressurizing mechanism increases a coupling stability between said heater assembly and said sump housing.

37. The sump assembly of claim 34, wherein said packing plug is made of a pliant material.

38. The sump assembly of claim 34, wherein said pressurizing mechanism is operated to deform said packing plug.

39. The sump assembly of claim 34, wherein said packing plug has a thickness greater than a depth of the opening of said heater port.

40. The sump assembly of claim 34, wherein said pressurizing mechanism is disposed on opposite sides of said packing plug.

41. The sump assembly of claim 34, said pressurizing mechanism comprising:
an opposing pair of plates interposing said packing plug.

42. The sump assembly of claim 34, wherein said pressurizing mechanism is operated to expand laterally said packing plug.

43. The sump assembly of claim 42, wherein the lateral expansion of said packing plug prevents said packing plug from escaping from the opening of said heater port.

44. The sump assembly of claim 34, said pressurizing mechanism comprising:
a compression device for tightening and loosening the fit of said packing plug to the opening of said heater port.

45. The sump assembly of claim 44, wherein said compression device is operable from outside of said sump housing.

46. A sump assembly of a dishwasher, comprising:
a sump housing for storing water;
a heater assembly for heating the stored water; and
an impeller, provided inside said sump housing and disposed above said heater assembly, for forcing the heated water out of said sump housing.

47. A dishwasher, comprising:
a washing chamber for accommodating articles to be washed;
a sump housing, disposed under said washing chamber, for collecting and storing water;
a heater assembly for heating the stored water;
a water supply pump, coupled to said sump housing, for pumping the heated water from inside said sump housing above said heater assembly; and
at least one spray nozzle, communicating with said sump housing, for spraying the pumped water into said washing chamber.
